(19) United States
(12) Patent Application Publication
(10) Pub. No.: US 2010/0166167 A1
(43) Pub. Date: Jul. 1, 2010

(54) Method and Apparatus for Managing Subscriber Profile Information

(75) Inventors: Bizhan Karimi-Cherkandi, Boca Raton, FL (US); Farrokh Mohammadzadeh Kouchri, Boca Raton, FL (US)

Correspondence Address: LERNER GREENBERG STEMER LLP, P O BOX 2480, HOLLYWOOD, FL, 33022-2480, US

(73) Assignee: NOKIA SIEMENS NETWORKS GMBH & CO. KG, München (DE)

(21) Appl. No.: 11/910,703

(22) PCT Filed: Mar. 28, 2006
(86) PCT No.: PCT/EP2006/061100

§ 371 Date: Nov. 1, 2007

Related U.S. Application Data
(60) Provisional application No. 60/667,996, filed on Apr. 4, 2005.

(51) Int. Cl. H04M 3/42; G06F 17/30

(52) U.S. Cl. 379/201.05; 707/812; 707/E17.009

(57) ABSTRACT

A method and an apparatus are provided for managing subscriber profile information. The method provides a database containing a global subscriber profile, wherein the global subscriber profile includes the subscriber profile information. A network element serving a subscriber terminal requests information from the global subscriber profile associated with a subscriber identity presented by the subscriber terminal. The method then determines if all global subscriber profile information required for performing a function of the network element is compatible with the network element and transforms incompatible information into information compatible with the network element.

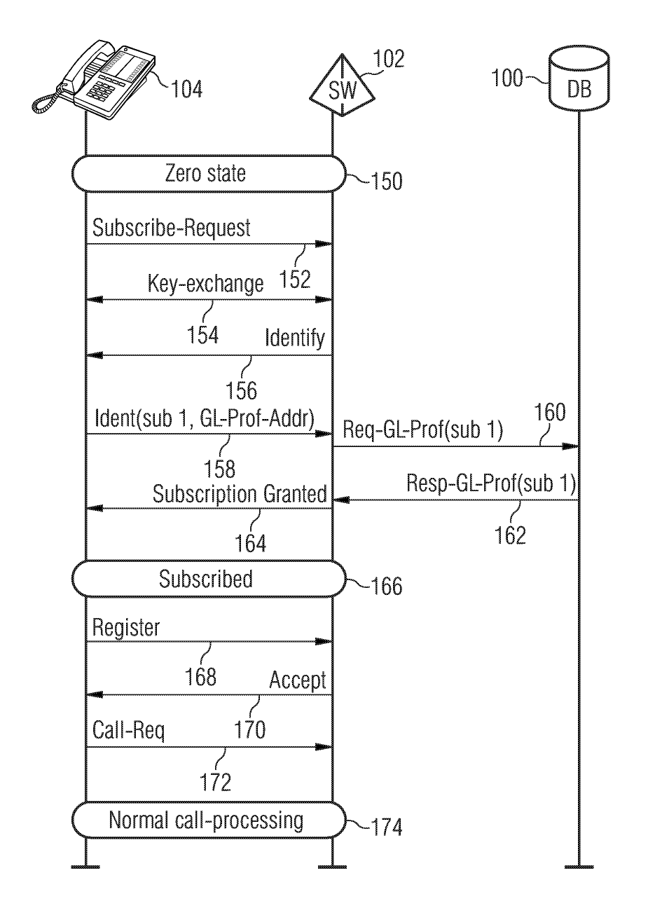

This application is related to and claims the benefit of commonly-owned U.S. Provisional Patent Application No. 60/667,996, filed Apr. 4, 2005, titled “Method and Apparatus for Global Subscriber Profile” which is incorporated by reference herein in its entirety.

The present invention relates to a method and apparatus for managing subscriber profile information.

Telecommunications networks are currently evolving from traditional circuit based networks to packet based networks, often referred to as Next Generation Networks (NGN). In a NGN, a subscriber's terminal equipment interfaces with the network by means of a Point of Presence (POP). A network operator may allow a subscriber to use an arbitrary POP for connecting to the network, thereby allowing the subscriber to roam freely within the geographical and physical boundaries set by the entirety of allowed POPs. A POP will normally mediate a connection between the terminal equipment and a network (soft) switch.

A clear advantage of the subscriber's ability to roam is that certain settings and personal information are available in different locations and independent of the terminal equipment used. Billing may conveniently occur through one single service provider.

A disadvantage of the present roaming implementations lies therein that subscriber profiles are stored in proprietary ways, normally in a “home” switch or a database closely associated with such home switch. In particular, when a subscriber decides to change his/her service provider, all profile information such as account and call feature settings will be lost, and services will most likely have different service access codes, e.g., operator assistance may not be available by dialing “0”. Further, a globally roaming subscriber will encounter several inconveniences when placing calls when roaming in a different country:
Access codes or service codes such as *69, used in the US for returning calls, may be assigned differently in the local switch serving the subscriber.

The subscriber will have to use his/her dialing plan because he is connected to his/her home office. To reach a local number he/she will have to dial an international call. Dialing “local” calls as international calls may also further restrict the use of call features.

It is therefore an object of the present invention to provide a novel method for handling subscriber profiles in telecommunications networks. It is another object of the present invention to provide an improved apparatus for telecommunications networks.

In accordance with the foregoing objects, there is provided by the invention a method for managing subscriber profile information in a telecommunications network. The method comprises:
providing a database comprising a global subscriber profile, said global subscriber profile comprising said subscriber profile information;
from a network element serving a subscriber terminal, requesting information from the global subscriber profile associated with a subscriber identity presented by said subscriber terminal;
determining if all global subscriber profile information required for performing a function of the network element is compatible with the network element and transforming incompatible information into information compatible with the network element.

The invention also provides a network element of a telecommunications network, comprising:
receiving means for receiving a subscriber identity from a subscriber terminal;
means for requesting information associated with the subscriber identity from to a database comprising a global subscriber profile, said global subscriber profile comprising said subscriber profile information;
means for determining if all global subscriber profile information required for performing a function is compatible with the network element and transforming incompatible information into information compatible with the network element.

The network element may decide to request the entire global profile or only portions of the global subscriber profile.

Transforming incompatible information may, in respective embodiments, comprise any or any combination of the following:
transforming feature access codes, e.g. providing a translation of a subscriber dialed “*69” into a (digit or tone) representation compatible with the currently serving network;
transforming dialing plan information, e.g. providing a translation (table) for international call prefixes codes and/or providing a translation such that local calls at the subscriber's present location may be dialed as local calls rather than international calls;
transforming service access codes, e.g. providing a translation for service numbers such as “0” for operator assistance or “911” or “110” for emergency assistance into a (digit or tone) representation compatible with the currently serving network.

Embodiments of the invention will now be described in more detail with reference a drawing. In the FIGURE, there is schematically shown a database or database server 100, a network element 102 such as a telecommunications switch, preferably a softswitch, and a subscriber terminal 104. Database 100, network element 102, and terminal 104 may reside in the same telecommunications network. Alternatively, database 100, network element 102, and terminal 104 may reside in different sections of the same telecommunications network, or in different (telecommunications and/or data) networks.

Terminal 104 is shown to be communicatively coupled to network element 102. Communication between terminal 104 and network element 102 may be effected by any known communications protocol including, but not limited to telecommunications methods such as ISDN, protocols such as the Session Initiation Protocol (SIP), or proprietary methods such as Skype. Further network elements (not shown) may be present in the path between terminal 104 and network element 102.

Network element 102 is shown to be communicatively coupled to database server 100. Communication between terminal 104 and network element 102 may be effected by any known communications protocol including, but not limited to packet protocols such as the Internet Protocol (IP). Further network elements (not shown) may be present in the path between network element 102 and database 100.

Operation of the preferred embodiment may start with an initial, or zero, state 150. Terminal 104 sends a subscribe request 152 to switch 102 in response to some subscriber input at terminal 104. Alternatively, terminal 104 may send subscribe request 152 automatically on activation or power up. The destination of subscribe request 152 may, for example, be determined from a locally stored preset or by means of an automatic discovery process. An identification and authentication process may comprise an exchange of security keys (step 154) between terminal 104 and switch 102. Upon verification of the security information switch 104 sends an “Identify” request to terminal 104 (step 156), whereupon terminal 104 provides the subscriber's identity information comprising, for example, a unique subscriber identifier and/or address information pointing to the subscriber's global profile stored in database 100 (step 158). Switch 102 uses the information supplied during step 158 to request the subscriber's profile from database 100 (step 160). In step 162, database 100 provides the requested profile information to switch 102. Switch 102 may decide to request the entire global profile or only portions of the global subscriber profile. Accordingly, the entire profile or only portions of it will be provided in step 162. Request 160 and response 162, and the communication between switch 102 and database 100 in general, may be subject to an individual and two-way authentication and security mechanism. In an embodiment, response 162 may convey only the portion of a subscriber's global profile which is allowed to be shared with the requesting switch or switch type. Portions of the global profile may thus be configured to be unavailable to certain switches, networks, or types of switches or networks.

Switch 102 receives the profile information and performs a check to determine if all global subscriber profile information required for performing a function is compatible with switch 102 and/or the network section switch 102 resides in.

The subscriber's global profile may, for example, teach switch 102 that the subscriber normally dials “011” as international prefix to outgoing international calls. However, “011” may not be a valid international prefix at the subscriber's present location. Therefore, the switch may provide a translation of “011” to the international prefix valid at the current location, thereby establishing the compatibility of the information.

The subscriber's global profile may further comprise additional call addressing information commonly referred to as dialing plan, which may partially not be compatible with a given switch 102 or the network section switch 102 is residing in. Similar to what was explained above with respect to the international prefix, switch 102 replaces those parts of the dialing plan that are incompatible, thus allowing the subscriber, for example, to place local calls without having to dial national or international prefixes.

Likewise, the subscriber's global profile may specify that the subscriber's preference for reaching an operator is dialing “0”. The locally valid number for reaching an operator may however be a longer number unknown to the subscriber. Therefore, the switch may provide a translation of “0” to said longer number in order to allow the subscriber to continue to use “0” for operator assistance. The inventive method is thereby transparent to the subscriber and provides for more convenience. Of course, other service access codes such as “911” may be managed similarly.

Feature access codes such as “*69” for returning missed calls may be translated in a similar fashion to service access codes.

To avoid ambiguity, translation may occur to a globally unique service/feature access code, or service/feature identification code, which may also be stored in the subscriber's global profile along with the subscriber's preferred sequence for invoking the respective service/feature.

In an embodiment, the global profile may host all subscriber properties. The profile may be implemented such that it is open and flexible towards extendibility so that future enhancements, e.g. additional properties, may easily be migrated. The global profile empowers the subscribers and providers to port and migrate in a much more efficient manner without losing already existing subscriber environment.

If a subscriber switches (temporarily or permanently) to a network with a smaller capability set, the new network may choose to ignore sections of the global profile relating to unsupported features and operations in order to allow for downward compatibility.

The subscriber's directory number (DN) may be part of the global profile. Accordingly, switch 102 may assign this DN to terminal 104 and inform the network to route all calls to this DN to switch 102.

The present invention proves particularly useful in an environment with numerous coexisting providers, each specializing in specific services, allowing a subscriber to roam freely between providers and geographically.

In an environment where the subscriber always carries a personal terminal equipment 104 (or an identity module insertable into an arbitrary available terminal), the global profile (i.e., the portion of database 100 relating to this subscriber) may reside in the terminal or the identity module (not shown), in which case encryption and/or other protective methods may be applied to secure portions or entire content from unauthorized access. Alternatively, the global profile may reside in the subscriber's home switch or closely attached to it, wherein the home switch then assumes the task of database server 100.

1-9. (canceled)

10. A method for managing subscriber profile information in a telecommunications network, which comprises the steps of:
providing a database containing a global subscriber profile, the global subscriber profile including the subscriber profile information;
requesting, via a network element serving a subscriber terminal, information from the global subscriber profile associated with a subscriber identity provided by the subscriber terminal;
determining if all the subscriber profile information required for performing a function of the network element is compatible with the network element; and
transforming incompatible information into information compatible with the network element.

11. The method according to claim 2, wherein the transforming incompatible information step includes transforming feature access codes.

12. The method according to claim 10, wherein the transforming incompatible information step includes transforming dialing plan information.

13. The method according to claim 10, wherein the transforming incompatible information step includes transforming service access codes.

14. A network element for a telecommunications network, the network element comprising:
receiving means for receiving a subscriber identity from a subscriber terminal;
means for requesting information associated with the subscriber identity from a database containing a global subscriber profile, the global subscriber profile containing subscriber profile information; and
means for determining if all the subscriber profile information required for performing a function is compatible with the network element and transforming incompatible information into information compatible with the network element.

15. The network element according to claim 14, wherein said network element contains a soft-switch.

16. The network element according to claim 14, further comprising means for transforming feature access codes.

17. The network element according to claim 14, further comprising means for transforming dialing plan information.

18. The network element according to claim 14, further comprising means for transforming service codes.
